(19) United States
(12) Patent Application Publication
(10) Pub. No.: US 2005/0148432 A1
(43) Pub. Date: Jul. 7, 2005

(54) Combined omni-directional treadmill and electronic perception technology

(76) Inventor: David E. E. Carmein, Ann Arbor, MI (US)

Correspondence Address: Richard J. Bartz;Suite 350, 6750 France Avenue South, Edina, MN, 55435, US

(21) Appl. No.: 10/979,741

(22) Filed: Nov. 2, 2004

Related U.S. Application Data
(60) Provisional application No. 60/516,450, filed on Nov. 3, 2003.

(51) Int. Cl. G06F 17/00; G06T 1/00; A63B 22/02

(52) U.S. Cl. 482/8; 482/54

(57) ABSTRACT

An omni-directional treadmill combined with electronic perception technology operates to control the active surface of the treadmill to maintain the position of the user in the center of the active surface. The active surface of the treadmill has power driven belts that move to control the position of the user on the belts. The electronic perception technology employs pulsed infrared light combined with time-of-flight measurement to determine spatial coordinates of cloudpoints.

### CROSS REFERENCE TO RELATED APPLICATION

Applicant claims the priority benefit of U.S. Provisional Application Ser. No. 60/516,450 filed Nov. 3, 2003.

### FIELD OF THE INVENTION

The invention is in the field of human training, entertainment, exercise, and rehabilitation omni-direction treadmills and methods that permit the person using the treadmills to walk, run or crawl in any arbitrary direction. The omni-direction treadmills are combined with electronic perception systems that controls the operation of the omni-direction treadmills so that the user stays in the center of the treadmills.

### BACKGROUND OF THE INVENTION

An omni-directional treadmill, herein ODT, disclosed by D. E. E. Carmein in U.S. Pat. Nos. 5,562,572 and 6,152,864, incorporated herein, when combined with an immersive visual display system permits a user to walk, run, or crawl naturally around a synthetic environment. The ODT can also be combined with a body-lifting mechanism to simulate free-body flight, so that the user can freely transition between ground-space to 3-space. One of the challenges of such a system is to control the surface of the treadmill so that the user stays centered. Yet another challenge is to generate and project a digital representation of the user into the virtual environment so that the user as well as networked others may perceive the user in digital form. A further challenge is to sense user gestures and postures in order to control selected aspects of the virtual environment.

Electronic Perception Technology, herein EPT, developed by Canesta, Inc., employs pulsed infrared light combined with time-of-flight measurement to determine full spatial coordinates of arbitrarily illuminated points. Of particular interest is U.S. Pat. No. 6,614,422, incorporated herein, “Method and Apparatus for Entering Data Using Virtual Input Device”, Rafii, Bamji, Kareemi, Shivji. This patent discloses a system for sensing objects in 3-space and providing useful data sets for further manipulation and computer-human interfacing.

### SUMMARY OF THE INVENTION

Combining an ODT with a virtual reality environment permits a person to navigate virtual space using natural means: walking, running, or crawling. To function properly, the ODT's surface must be controlled so that the user stays in the center. Typically, a sensing means tells a controller where the user is with respect to the center of the ODT surface, the controller looks at the error between the ODT center and user position and makes the appropriate corrections by adjusting X and Y direction velocities. Sensing means have typically included electromagnetic sensors, inertial sensors, mechanical linkages, and fiduciary markers sensed by specialized cameras.

EPT provides a novel means of sensing user position to control the treadmill active surface. EPT provides a simple, low-cost way to create a real-time data set of 3-dimensional points that reflect user position. Thus, EPT data can be compared to the desired user position and used in a closed-loop control computer to adjust treadmill active surface X/Y velocities and re-center the user.

### OBJECTS OF THE INVENTION

It is a primary object of this invention to employ the 3-dimensional position-sensing capabilities of EPT to enable closed-loop control the velocity and heading of the ODT surface.

It another object of this invention to employ the pointcloud of data generated by EPT to permit generation of a surface model of the immersant, which can be shared within the virtual environment for mutual recognition in the virtual environment. Further, the surface model can be used for self-recognition.

A further object of this invention is to employ either the pointcloud or the surface model to derive a whole or partial skeletal model so that the skeleton can articulate any number of arbitrary avitar forms. The form can then be digitally integrated into a single experience or shared virtual environment.

It is yet another object of this invention to employ video cameras to capture color data and then back-map that data onto the surface model thus creating volume-pixel data, or “voxels”. This fully-colored and contoured form may be used for recognition purposes stated above. EPT already acquires gray-scale data (black and white) which could also be suitably texture-mapped onto the surface.

Yet another object of this invention is to use whole or partial body models derived from real body position to actively control elements of the virtual environment.

It is another object of this invention to employ EPT to derive shape data from objects besides the human immersant and to optionally show the objects' relative positions, while at the same time providing good indexing between what the user sees and what the user might feel. This is especially important for creating haptic feedback from real objects, or from robotic elements that simulate all or portions of real objects.

An additional object of this invention is to employ EPT on a sitting user to create a 3D model, as described above, and to place that model into a solo or shared virtual environment.

Another object of the desktop-based invention is to use EPT-driven EPT for highly detailed real-time views of selected body parts. As described above, a wide field of vision, herein FOV, EPT would direct narrower FOV EPT to the specific areas of detailed interest, such as the face or hands. Alternately, the wide FOV EPT may direct a secondary, fixed EPT with higher photoreceptor density to process only the receptors of interest.

A more specific object of this invention is to use the detailed models of the face and hands in a telecommunication application.

Another object variant of this invention is to integrate the body model into a fused dataspace that combines real, scanned or pre-modeled and virtual objects, and further permits interaction between said objects.

### DESCRIPTION OF THE DRAWING

FIG. 1 is a perspective view of an omni-directional treadmill combined with an electronic perception system showing a person centered on the active surface of the treadmill;

FIG. 2 is a perspective view of a pointcloud person on an omni-directional treadmill;

FIG. 3 is a perspective view of a pointcloud person on an omni-directional treadmill with video texture mapped onto the pointcloud;

FIG. 4 is a perspective view showing the electronic perception system sensing a real object registered to virtual space;

FIG. 5 is diagrammatic view showing two electronic perception systems used to provide a detailed surface model of the person's face;

FIG. 6 is a diagrammatic view of an electronic perception system viewing a non-omni-directional treadmill immersive user in standing position with leg motion indicating movement and heading indicating direction;

FIG. 7 is a diagrammatic view of an electronic perception system instrumental desktop with high density data set on hand for CAD application; and

FIG. 8 is a diagrammatic view of an electronic perception system showing a real and virtual integrated desktop gaming application.

### DETAILED DESCRIPTION OF THE INVENTION

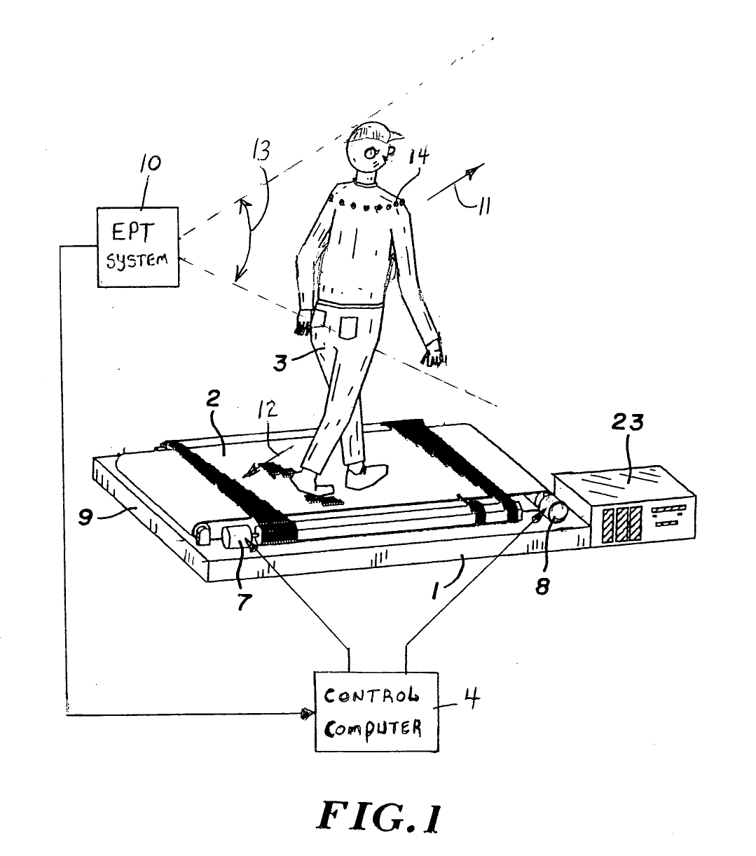

The combined omni-directional treadmill 1 and electronic perception system 10, shown in FIG. 1, depicts omni-directional treadmill 1 having a movable active surface 2 supporting a user or person 3. User 3 is positioned generally on the center of surface 2. Surface 2 is a belt structure operable to transport user 3 to any point on surface 2. A detailed disclosure of omni-directional treadmill 1 described and shown in U.S. Pat. Nos. 5,562,672 and 6,152,854, is incorporated herein. A user 3 that is headed off surface 2 is moved back toward the center of surface 2 to prevent user 3 from running off the front or being flung off the back of surface 2. A control computer 4 coordinates the operation of motors 7 and 8 that drive the belts of active surface 2. Computer 4 is coupled to EP system 10 which senses the location of user 3 on active surface 2. Motors 7 and 8 and active surface 2 are mounted on a rigid base 9. A computer 23 for image generation, sound generation, and processing of related data can be wired to a head-mounting display, herein a HMD.

User 3 is walking on active surface 2 in the direction of arrow 11. The EPT system 10 senses the user position relative to active surface 2 and feeds data to control computer 4. Computer 4 generates motor control signals that coordinate the operation of motors 7 and 8 to move active surface 2 in the opposite direction, shown by arrow 12, from the movement of user 3.

EPT system 10 uses pulsed infrared light combined with time-of-flight movements to provide data of full spatial coordinates of arbitrarily illuminated points. EPT system 10 has a selected field of vision 13 that encompasses user 3. A detailed disclosure of EPT system 10 described in U.S. Pat. No. 6,614,422 is incorporated herein.

A collection of spatially assigned points 14 on user 2 can be called a pointcloud. The pointcloud 14 generated by EPT system 10 is, by its nature, attached to the surface of the sensed object. These points can be connected together into a surface that closely resembles the surface from which they were derived. Such a surface model can then be depicted as a surface entity within the virtual environment, or it can be further processed to reveal the approximate location of the skeletal structure beneath. Knowledge of skeletal structure is useful because it enables a deeper understanding of the grounding elements as well as the intent of their motion.

Armed with this knowledge, a user 3 can hang a different body model on those bones while conveying the same intent. For example, a man in his 80's with spinal curvature and short legs can choose to drive a body model of an erect young man with long legs. Those interacting with the man in a virtual environment will perceive only the young man, whose actions will preserve the intent of the old.

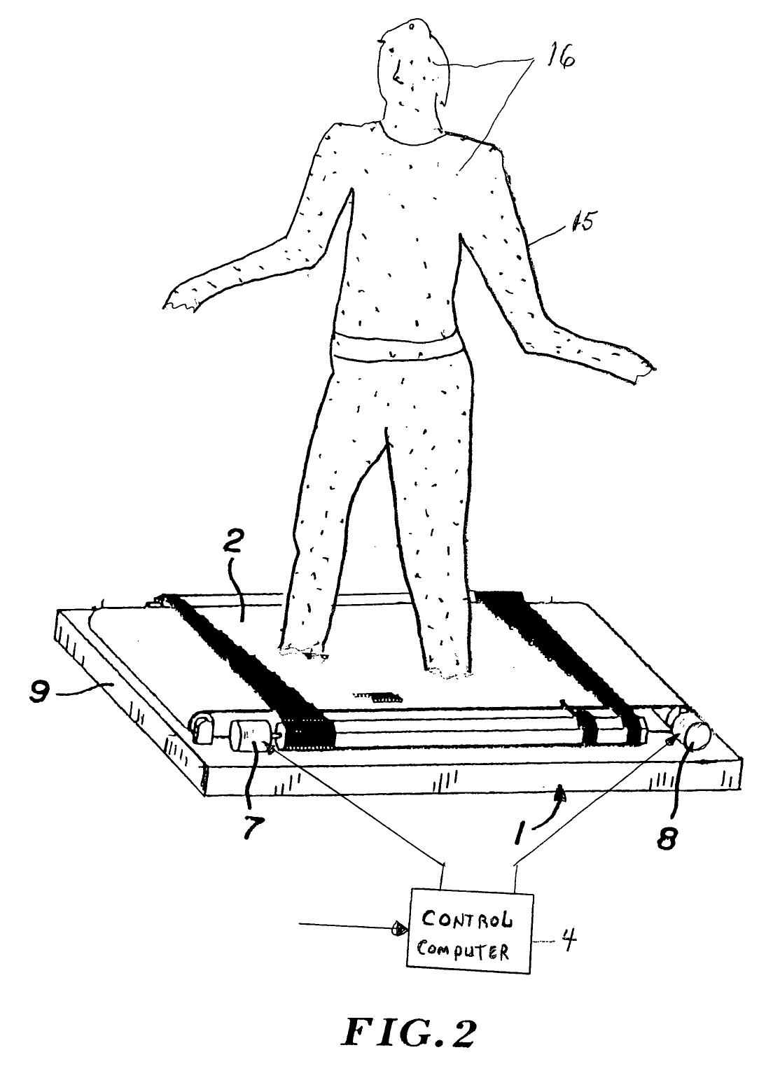

FIG. 2 shows the general idea of a surface map 15 derived from a point cloud 16. Surface map 15 has the outline of a treadmill user with point cloud 16 defining the map. The map can be persons, animals, products or objects in general. The surface map is a model of the person or object.

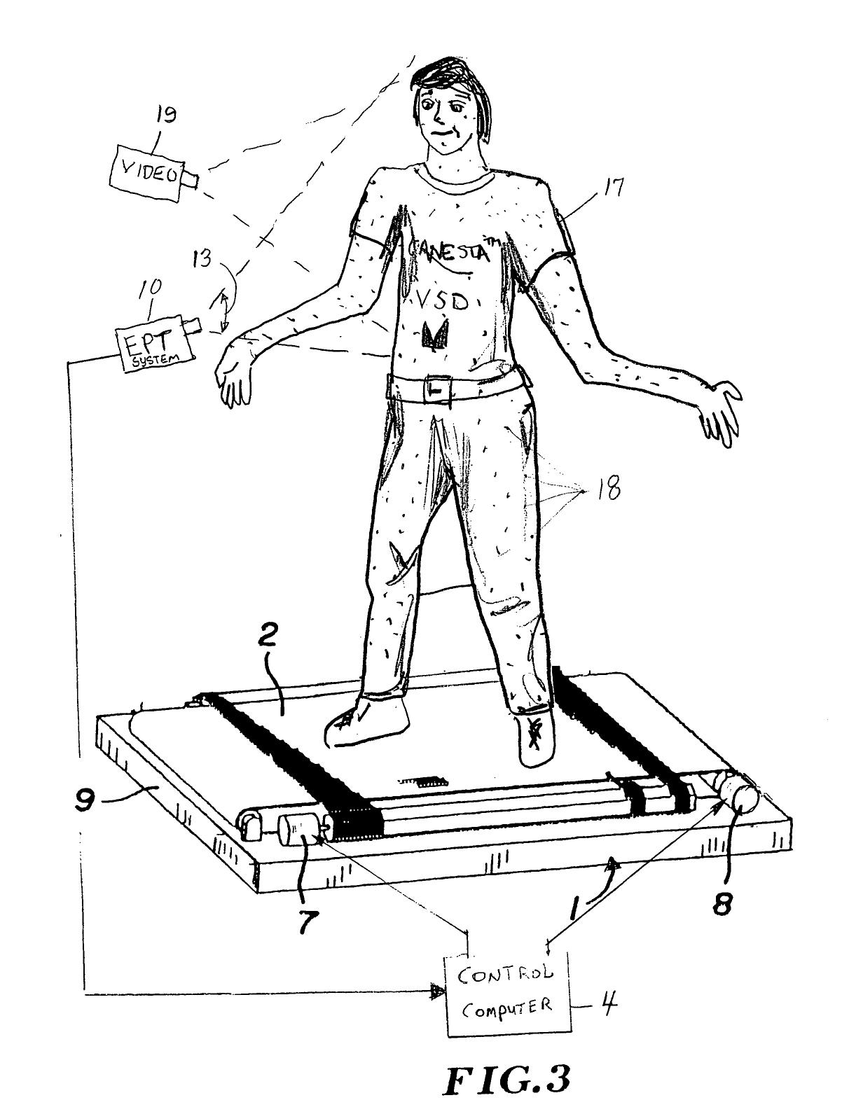

FIG. 3 shows a surface model 17 having the shape of a human body generated by EPT system 10 with pointcloud 18. A video device 19 first captures the image. Computer processing indexes the video image to the surface model 17. Mapping the video onto the 3D surface model creates a fully realistic digital model of the user. This model can now interact with its virtual environment, looking like the person driving the ODT 1, navigating freely and naturally.

Another useful and novel application of EPT sensing user position is that position, posture, and motion of either the whole body or select body elements can be used to control and direct action in the virtual environment. A real foot motivating a virtual foot can kick a virtual soccer ball towards the goal in a networked soccer game; a sweeping gesture of the hand might be used to erase a virtual white board; the tip of a finger might be used as a drawing tool to create art in an open virtual space; or a suspended body in virtual free-flight can be arched, and the arms tipped to mimic a bird soaring and turning in the autumn air.

EPT facilitation of creation of surface contours is useful in the ODT simulation environment because EPT can easily sense both the shape and the relative position of all objects within the viewing zone. EPT can therefore display relative positions of objects to the immersant. For example, a soldier wearing a head-mounted display would be able to see his hand model where his hand is, his rifle model in its proper place, and their relative position.

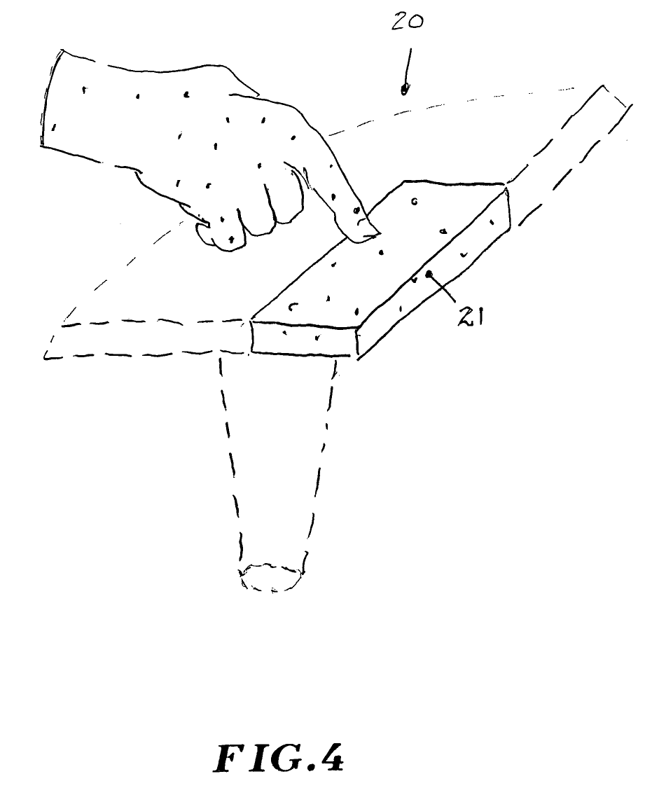

A person wearing an HMD could experience touch in virtual space by filling the real user space with an object that corresponds to what the viewer sees. For example, as shown in FIG. 4, if a user reaches out to touch the corner of a flat virtual table 20, a small, flat piece of wood 21 can index with the location of the virtual table. EPT will ensure proper placement of the real piece of wood with respect to the model. FIG. 4 shows such an interaction.

One can also fill the real space with moving objects whose indexing with its virtual doppelganger is assured by EPT. We are assured of seeing whole human bodies robotized and placed within the user's contact zone to represent the physical presence of a likewise-networked remote user. In such an instance, user 1 might reach out to touch the hand of the user 3 in the virtual environment. Employing the inventive technology described herein, each of the users has in his/her ODT zone a robot whose actions mimic those of the user driving it. Thus, as user 1 reaches for user 3, robot's hand reaches toward the warm, very real human hand in ODT 1. The user, of course, feels a hand right where it should be. EPT observes all motion, quantifies it, and places it in its proper relative and absolute position within the real and virtual environments.

As described above, EPT helps solve the “end effecter” problem wherein a multi-linkage actuator cannot know its true end point because of uncertainty at each joint. EPT just looks at the end element and provides real location data, which can in turn be employed by standard PID type control loops to provide accurate positioning.

Interactions of this type are not limited to the ODT environment. Indexing real and virtual objects can occur within any defined space, such as at a desktop.

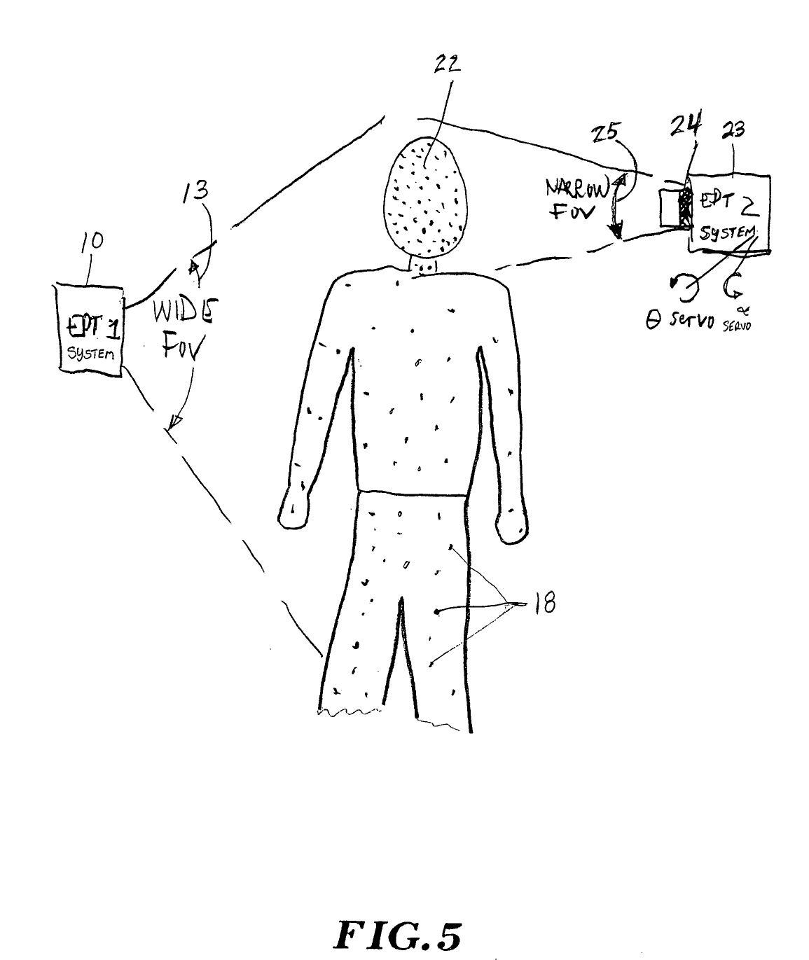

EPT can also be used to control EPT itself. For example, as shown in FIG. 5, if one wished for a detailed surface model of the face 22, then one desires as much of the face within the field of view of the camera as possible to maximize the available pixel density. A whole-body EPT scan by EPT system 10 can be employed to locate the face, and then a secondary camera 23 with a narrower field-of-view (FOV) can be actively aimed at the face. The bounding box from the first EPT data set will tell the slaved camera all the information it needs to center and focus the image. Alternatively, the variable focus lens of the camera, which focuses to the proper Z distance, can be set to auto focus, as do low-cost commercial video cameras. Similar, more detailed data can be extracted from other select portions of the body, like the hands. See FIG. 5.

A variation on EPT-driven EPT is to employ EPT 10 to determine a preferred data zone, and then process only a select zone of photonic receptors in the receptor array of EPS 23. The advantage of such a system is that EPT 23 does not need to be servo driven, but rather just needs to have a higher receptor density than EPT 10. Processing only a select number of receptors keeps EPT processing frequency high while at the same time getting good detail from a zone of specific interest.

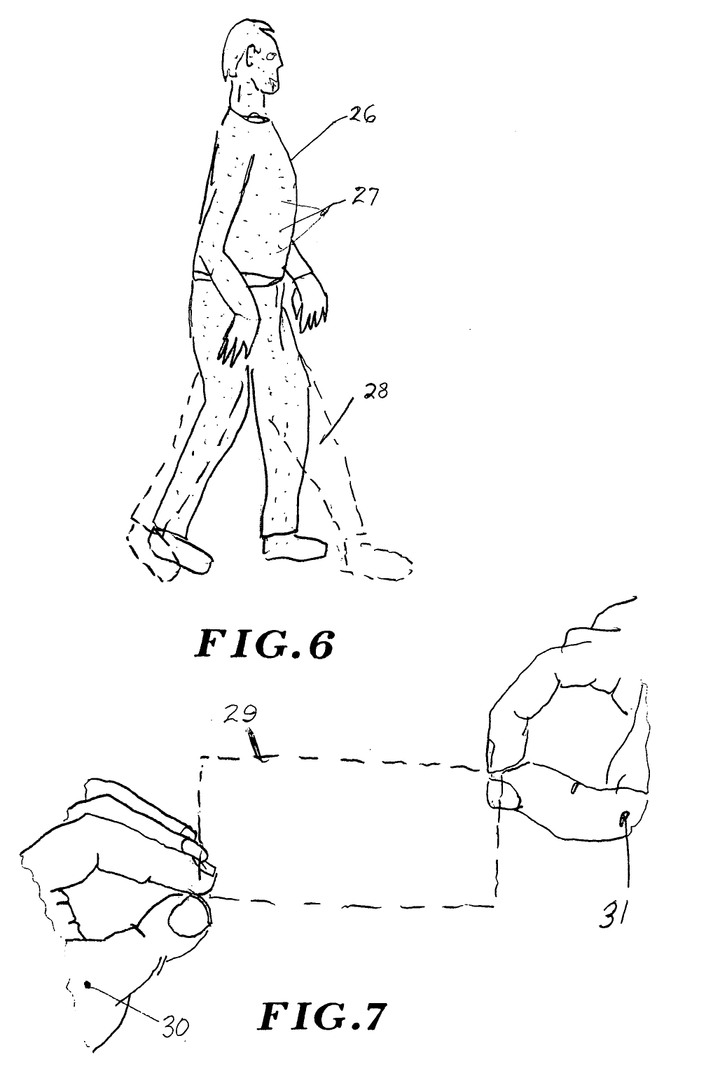

Of course, an ODT need not be present in order to acquire meaningful EPT data for communication in virtual environments. A user could be simply standing in place with an HMD with EPT chunking real-time data of the immersant as before. In this variation, one can imagine using the hands for navigation, or using EPT to sense the motion of the feet and legs, and use that motion to create a walking or running model (Templeman, et al.). FIG. 6 shows such an interface. Model 26 generated with pointcloud 27 shows motion of leg 28.

Naturally, single or multiple EPT modules can be used to sense the upper body of a person sitting at a desk. More interesting is the use of EPT driven EPT, as described above, to get highly detailed views of the face or hands. One can imagine teleconferencing with full 3D renditions of the face. A single EPT digitized hand can be used in place of a mouse. Two hands can be employed in a computer-aided design environment to shape wireform objects, or virtually sculpt solids 26. FIG. 7 depicts an upper body application including hands 27 and 28 of this type for CAD, where the teleconferencing is implied.

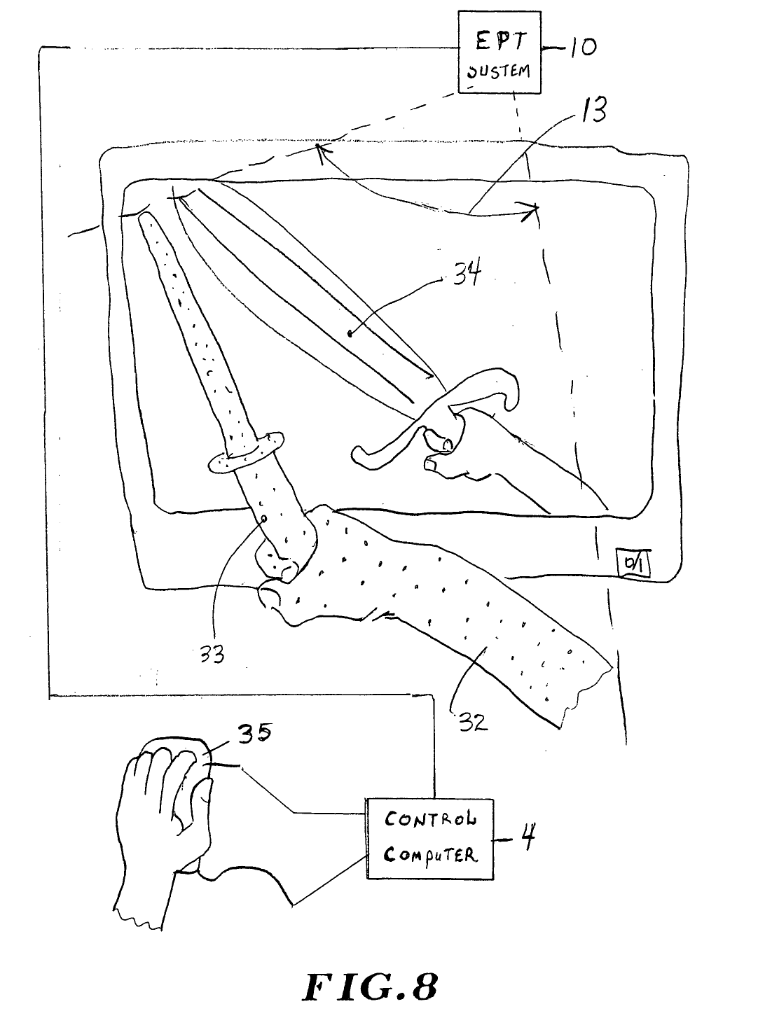

As the desktop environment becomes more immersive, either through use of large, fully 3D screens, or an HMD, EPT can enable data fusion of real and virtual elements to create one seamless environment. The user can see a clear and accurate model of their own hands and any select part of the real environment, like the keyboard or desktop, along with virtual objects. For example, a shown in FIG. 8, gaming environments would sense the user 29 along with a weapon 30, such as a sword or pistol. As the sword is moved in real space, the simulation on the screen would show a like sword 31 in the virtual space. And the virtual sword would do the digital work. The object in the viewer's hand needn't be full-sized. A quarter-scale sword at the desktop would permit free movement in front of the screen, while a full-scale sword does the damage in the game. FIG. 8 depicts one such integrated scene where the user navigates using a mouse 32, and does battle with a quarter-scale sword.

Head tracking using EPT can also be used to navigate through the virtual space at the desktop. This is especially useful if both hands are otherwise occupied. For example, tipping the head forward could proportionally move the user forward through the scene. Likewise, turning the head left or right could move them L/R. This approach is similar to joystick navigation except that the angle of the head is used instead of the angle of the joystick.

With an HMD on, certain portions of the upper face cannot be observed by EPT. To avoid this loss of detail during HMD use, users can first have their face scanned by EPT and video without the HMD. Using this earlier-acquired facial model, the missing portion can be mapped onto the observable portion. A secondary technology might used to fuse with the EPT dataset in this case. For instance, eye position sensing underneath the HMD can be combined with the EPT set for a relatively full facial model.

Certain muscle groups are known to move together, and these groups can be modeled and combined with EPT for a more realistic display. For instance, a smile will bunch up muscles under the eye and crinkle the corners of the eye. An HMD blocks those portions of the eye, but EPT can sense the smile, and so drive the total facial model.

The invention has been described with reference to preferred embodiments. Modifications, changes and alterations in the structures of the treadmill and electronic perception technology can be made by person skilled in the art without departing from the scope of the invention.

1. In combination: a treadmill having a movable active surface, adapted to support a user, an electronic perception system operable to determine spatial coordinates of the illuminated points on the user and generating signals representing the spatial coordinates of illuminated points, and a control computer accommodating said signals and controlling the movement of the active surface in accordance with said signals to maintain the user on the active surface of the treadmill.

2. The combination of claim 1 wherein: the movable active surface of the treadmill includes a movable belt apparatus for supporting the user and electric motors operably connected to the belt apparatus for moving the belt apparatus, said control computer being operably connected to said motors whereby the motors move the belt apparatus in a direction determined by said signals to maintain the user on the belt apparatus of the treadmill.

3. The combination of claim 1 wherein: the treadmill is an omni-directional treadmill.

4. The combination of claim 1 wherein: the electronic perception system includes first means for generating light and directing the light toward the object surface, and second means for measuring the time-of-flight of said light to and from the illuminated points to provide said signals representing the spatial coordinates of the illuminated points.

5. The combination of claim 1 wherein: the movable active surface of the treadmill includes a movable belt apparatus for supporting the user and electric motors operably connected to the belt apparatus for moving the belt apparatus, said control computer being operably connected to said motors whereby the motors move the belt apparatus in a direction determined by said signals to maintain the user on the belt apparatus of the treadmill, said electronic perception system including first means for generating infrared light and directing the light toward the illuminated points, and second means for measuring the time-of-flight of said infrared light to and from the illuminated points to provide said signals representing the spatial coordinates of the illuminated points.

6. In combination: a first means having a movable active surface adapted to support a user, second means operable to determine spatial coordinates of illuminated points on the user and generate signals representing the spatial coordinates of the illuminated points, and third means accommodating said signals and controlling the movement of the active surface in accordance with said signals to maintain the user on the active surface.

7. The combination of claim 6 wherein: the moveable active surface includes a movable belt apparatus for supporting the user, and electric motor means operably connected to the belt apparatus for moving the belt apparatus, said third means being operably connected to said motor means whereby the motor means move the belt apparatus in a direction determined by said signals to maintain the user on the belt apparatus.

8. The combination of claim 6 wherein: the second means includes means for generating light and directing the light toward the object surface, and means for measuring the time-of-flight of said light to and from the illuminated points to provide said signals representing the spatial coordinates of the illuminated points.

9. The combination of claim 6 wherein: the moveable active surface includes a movable belt apparatus for supporting the user, and electric motor means operably connected to the belt apparatus for moving the belt apparatus, said third means being operably connected to said motor means whereby the motor means move the belt apparatus in a direction determined by said signals to maintain the user on the belt apparatus, the second means including means for generating light and directing the light toward the object surface, and means for measuring the time-of-flight of said infrared light to and from the illuminated points to provide said signals representing the spatial coordinates of the illuminated points.

10. A method of maintaining a user generally on the center of an active surface of a treadmill comprising: locating illuminated points on the user, determining the spatial coordinates of the illuminated points on the user, generating signals representing the spatial coordinates of the illuminated points, moving the active surface of the treadmill, and controlling the movement of the active surface in accordance with said signals to maintain the user generally on the center of the active surface of the treadmill.

11. The method of claim 10 wherein: the active surface of the treadmill is a belt apparatus for supporting a user, said method including moving the belt apparatus, and controlling the movement of the belt apparatus in accordance with said signals to maintain the user generally on the center of the belt apparatus of the treadmill.

12. The method of claim 10 wherein: the spatial coordinates are determined by generating light, directing the infrared light toward the object surface, and measuring the time-of-flight of said light to and from the illuminated points to provide said signals representing the spatial coordinates of the illuminated points.

13. The method of claim 10 wherein: the active surface of a treadmill is a belt apparatus for supporting a user, said method including moving the belt apparatus, and controlling the movement of the belt apparatus in accordance with said signals to maintain the user generally on the center of the belt apparatus of the treadmill, the spatial coordinates being determined by generating light, directing the light toward the object surface, and measuring the time-of-flight of said light to and from the illuminated points to provide said signals representing the spatial coordinates of the illuminated points.

14. A digital model of a person comprising: first means for creating a surface model of a person, and second means adding video images to said surface model.

15. The digital model of claim 14 wherein: the first means comprises an electronic perception system operable to determine spatial coordinates of illuminated points outlining said surface model and generating signals representing the spatial coordinates of the illuminated points.

16. The digital model of claim 14 wherein: the second means includes a video camera operable to project a video image on said surface model.

17. A digital model of a person comprising: first means for creating a gross surface model of a person, and second means for creating a detailed surface model of a portion of a person.

18. The digital model of claim 17 wherein: the second means comprises an electronic perception system operable to determine spatial coordinates of the portion of the person and generating signals representing the spatial coordinates of the illuminated points of the portion of the person.
